(19) United States
(12) Patent Application Publication
(10) Pub. No.: US 2008/0073812 A1
(43) Pub. Date: Mar. 27, 2008

(54) Manufacturing method of separator for fuel cell using preform and separator manufactured by the same

(75) Inventors: Seung Hun Jung, Gyeonggi-do (KR); Yoo Chang Yang, Gyeonggi-do (KR); Min Kyu Song, Seoul (KR); Kyung Sup Han, Gyeongsangbuk-do (KR); Sung Il Huh, Gyeongsangbuk-do (KR); Kyeong Seok Oh, Gyeongsangbuk-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/635,353

(22) Filed: Dec. 6, 2006

(30) Foreign Application Priority Data
Sep. 21, 2006 (KR) 10-2006-0091782

(51) Int. Cl. B29C 39/12

(52) U.S. Cl. 264/250

(57) ABSTRACT

Disclosed are a manufacturing method of a separator for a fuel cell, comprising a preforming step for forming a preform of the separator and a main forming step for form the separator with the preform; and a separator manufactured thereby.

### CROSS-REFERENCE TO RELATED APPLICATION

This application claims priority to and the benefit of Korean Patent Application No. 10-2006-0091782 filed in the Korean Intellectual Property Office on Sep. 21, 2006, the entire contents of which are incorporated herein by reference.

### BACKGROUND OF THE INVENTION

(a) Field of the Invention

The present invention relates to a manufacturing method of a separator for a fuel cell using a preform and a separator manufactured by the same, and more particularly to a manufacturing method of a separator by two forming processes of a preforming and a main forming so as to reduce forming time at high temperature and high pressure and a separator manufactured by the same.

(b) Background

Fuel cells are expected to provide a practical form of power generation with high efficiency and little air pollution. Among these, polymer electrolyte membrane fuel cells (PEMFC) are receiving more and more attention, especially for vehicle propulsion purpose

The PEMFC uses as its electrolyte a polymer membrane. This membrane is an electronic insulator, but an excellent conductor of hydrogen ions. The PEMFC transforms the chemical energy liberated during the electrochemical reaction of hydrogen fuel and oxygen from the air to electrical energy, as opposed to the direct combustion of hydrogen and oxygen gases to produce thermal energy. To prepare the PEMFC, porous air electrode and fuel electrode are coated by precious metal catalyst and the polymer electrolyte membrane is then sandwiched between the electrodes. This electrode/electrolyte unit is sandwiched between two separators that channel the fuel to the electrodes.

The separator serves as a support member for the unit cell and a passage of reaction gas of hydrogen and air and coolant. It is required to have excellent electrical conductivity, high mechanical strength, and low gas transmissivity. Conventionally, graphite has been used to manufacture PEMFC separators. Pure graphite has excellent electrical conductivity and high corrosion resistance, but it contains lots of blowholes that make it difficult to form a channel therein.

Typically, such composite separators have been manufactured by a compression molding or an injection molding process. Compression molding processes, however, have a drawback that the manufacturing time is too long, making it hard to reduce costs for manufacturing a separator, which possess almost 60% of the overall costs for manufacturing a fuel cell.

Injection molding processes also have drawback that the composite separators formed have a lower electrical conductivity than the separators formed through the compression molding processes.

Thus, there is a need to provide a separator and a method for manufacturing the same that overcome the inherent problems associated with the conventional methods.

### SUMMARY OF THE INVENTION

In one aspect, the present invention provides a two-step manufacturing method of a separator for a fuel cell. In the first step, a preform of the separator is formed. In the second step, the separator is formed using the preform.

The preforming step may comprise the steps of: (a) mounting first side molds to both sides of a first lower mold; (b) filling an inner space formed by the first lower mold and the first side molds with a material mixture; (c) moving a spreader forward and backward so as to uniformly disperse the mixture corresponding to height of the first side molds; (d) mounting an additional mold on the first side molds so as to adjust a filling height of the mixture; and (e) mounting a first upper mold on the mixture.

In one embodiment, the material mixture may comprise expanded graphite, flaky graphite, and phenolic resin.

A preferred composition of the mixture may be 2 to 20% of expanded graphite by weight, 40 to 70% of flaky graphite by weight, and 20 to 40% of phenolic resin by weight.

In another embodiment, the material mixture may comprise expanded graphite, carbon fiber, and phenolic resin.

Preferably, the mixture may comprise 6 to 32% of expanded graphite by weight, 30 to 60% of carbon fiber by weight, and 35 to 40% of phenolic resin by weight.

Suitably, the preform may be formed at a thickness of 5 to 15 mm for 5 to 10 minutes at a temperature of 100 to 120° C. in a state in which the first upper mold is mounted.

Also suitably, four edges of the preform may be formed to be less by 0 to 5 mm than a size of the separator. The thickness of the preform may be greater than that of the separator.

The main forming step following the preforming step may comprise the steps of: (a) mounting second side molds to both sides of a second lower mold; (b) inserting the preform into a space formed by the second lower mold and the second side molds; and (c) mounting a second upper mold on the preform.

Preferably, the preform may be preheated for 10 to 60 seconds at temperature of 150 to 180° C. at low pressure under 0.5 Mpa. Also preferably, after the preheating process, pressure of 1 to 5 MPa may be applied and withdrawn so as to remove blowholes inside the mixture in a state in which the second upper mold is mounted. The separator may be made by forming the preform with pressure of 3 to 15 MPa for 1 to 5 minutes.

In another aspect, the present invention provides a PEMFC separator formed with a mixture comprising expanded graphite, flaky graphite, and phenolic resin.

A preferred composition of the mixture may be 2 to 20% of expanded graphite by weight, 40 to 70% of flaky graphite by weight, and 20 to 40% of phenolic resin by weight.

In still another aspect, the present invention provides a PEMFC separator formed with a mixture comprising expanded graphite, carbon fiber, and phenolic resin.

Preferably, the mixture may comprise 6 to 32% of expanded graphite by weight, 30 to 60% of carbon fiber by weight, and 35 to 40% of phenolic resin by weight.

In a further aspect, motor vehicles are provided that comprise a described separator.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present separators will be particularly useful with a wide variety of motor vehicles.

Other aspects of the invention are discussed infra.

### BRIEF DESCRIPTION OF THE DRAWINGS

FIG. 1 is a schematic diagram showing a preforming step of a manufacturing method of a separator for a fuel cell according to an exemplary embodiment of the present invention.

FIG. 2 is a schematic diagram showing a main forming step of a manufacturing method of a separator for a fuel cell according to an exemplary embodiment of the present invention.

FIG. 3 is a graph showing numerical data regarding the preforming step shown in FIG. 1.

FIG. 4 is a graph showing numerical data regarding the main forming step shown in FIG. 2.

FIG. 5 is a top plan view showing positions of test articles for measuring density, electrical conductivity, and bending strength of a separator for a fuel cell according to an exemplary embodiment of the present invention.

FIG. 6 is a graph showing density distribution of a first embodiment of the present invention.

FIG. 7 is a graph showing electrical conductivity distribution of a first embodiment of the present invention.

FIG. 8 is a graph showing bending strength distribution of a first embodiment of the present invention.

FIG. 9 is a graph showing density distribution of a second embodiment of the present invention.

FIG. 10 is a graph showing electrical conductivity distribution of a second embodiment of the present invention.

FIG. 11 is a graph showing bending strength distribution of a second embodiment of the present invention.

Reference numerals set forth in the Drawings includes reference to the following elements as further discussed below:

| | |
|---|---|
| 10: first lower mold | 12: first side mold |
| 13: mixture | 14: additional mold |
| 15: first upper mold | 16: suspending rod |
| 17: perform | 19: spreader |
| 20: second lower mold | 21: second side mold |
| 22: second upper mold | |

### DETAILED DESCRIPTION

Exemplary embodiments of the present invention will hereinafter be described in detail with reference to the accompanying drawings. Like reference numerals refer to like elements throughout. The embodiments are described below so as to explain the present invention by referring to the figures.

As discussed above, in one aspect, the present invention provides a two-step manufacturing method of a separator for a fuel cell: (a) preforming step and (b) main forming step.

In a first preferred embodiment, a separator for a fuel cell may be a composite separator reinforced by flaky graphite. This separator is made of a mixture 13 comprising expanded graphite, flaky graphite, and phenolic resin through the preforming step A and the main forming step B.

A preferred composition ratio of the mixture 13 is 2 to 20% of expanded graphite by weight, 40 to 70% of flaky graphite by weight, and 20 to 40% of phenolic resin by weight.

The expanded graphite can easily form conductive network, has great filling volume, and tends to be tangled with one another and it is advantageous in forming the preform 17. If the amount of the expanded graphite is less than 2% by weight, the filling volume becomes so small that it is difficult to form the preform 17. On the other hand, if the amount of the expanded graphite is greater than 20% by weight, the filling volume becomes so large that internal gas cannot easily leak out and the bending strength of the separator cannot be sufficiently reinforced. Accordingly, it is preferable that the amount of the expanded graphite is 2 to 20% by weight.

The flaky graphite serves to reinforce the strength of the separator together with the phenolic resin. If the amount of the flaky graphite is less than 40% by weight, the bending strength cannot be sufficiently reinforced. In contrast, the amount of the flaky graphite is greater than 70% by weight, it disturbs the formation of conductive networks by the expanded graphite so that the conductivity is substantially deteriorated. Accordingly, it is preferable that the amount of the flaky graphite is 40 to 70% by weight with particle size of 50 to 500 μm.

The phenolic resin serves to improve a formability of a separator and is used as a powder type. If the amount of the phenolic resin is less than 20% by weight, the formability is deteriorated. By contrast, if the amount of the phenolic resin is greater than 40% by weight, the conductivity is deteriorated so as to lessen the strength of the separator. Accordingly, it is preferable that the amount of the phenolic resin is 20 to 40% by weight.

In a second preferred embodiment, a separator for a fuel cell may be a composite separator reinforced by carbon fiber. This separator is made of a mixture 13 comprising expanded graphite, carbon fiber, and phenolic resin through the preforming step and the main forming step.

Preferably, the mixture may comprise 6 to 32% of expanded graphite by weight, 30 to 60% of carbon fiber by weight, and 35 to 40% of phenolic resin by weight.

If the amount of the expanded graphite is less than 6% by weight, the electrical conductivity the separator becomes less than a reference value for a separator for a fuel cell due to excessive amount of carbon fiber. On the other hand, if the amount of the expanded graphite is greater than 32% by weight, the bending strength may not be sufficient. Accordingly, it is preferable that the amount of the expanded graphite is 6 to 32% by weight.

If the amount of the carbon fiber is less than 30% by weight, the bending strength cannot be sufficiently reinforced. In contrast, if the amount of the carbon fiber is greater than 60% by weight, the mixture cannot be densified because of the resistance with respect to high pressure, thereby making the electrical conductivity of the separator fall below a reference value thereof. Accordingly, it is preferable that the amount of the carbon fiber is 30 to 60% by weight with particle size of 10 to 15 μm×200 to 250 μm.

Like the first embodiment described above, the amount of the phenolic resin is preferably 20 to 40% by weight, but it is more preferable that the amount of the phenolic resin is 35 to 40% by weight according to ratios of the expanded graphite and the carbon fiber.

Polymers such as epoxy resin, vinyl ester resin, polypropylene (PP) resin, polyvinylidene fluoride (PVDF) resin, or polyphenylene sulfide (PPS) resin may be used instead of the phenolic resin used in the first and the second embodiments of the present invention.

The mixture 13 is prepared by mixing expanded graphite, reinforcing material (i.e., flaky graphite or carbon fiber), and polymer (e.g., phenolic resin) in the above-mentioned composition ratio for 30 minutes, and is subjected to the preforming step A and the main forming step B.

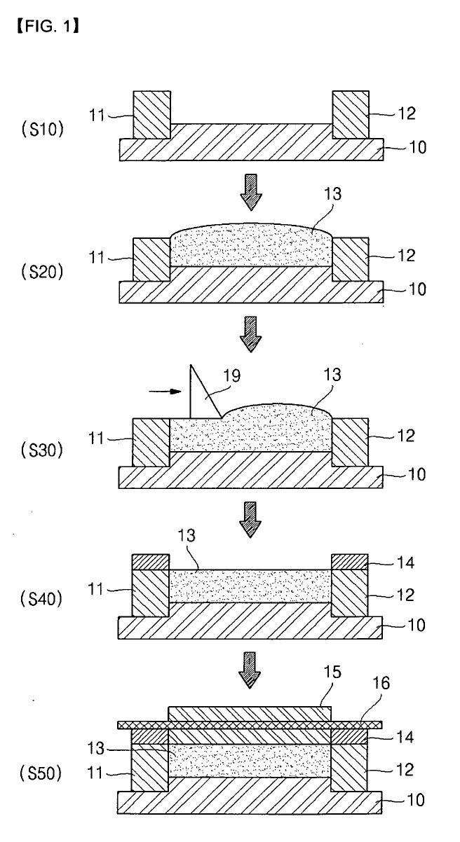

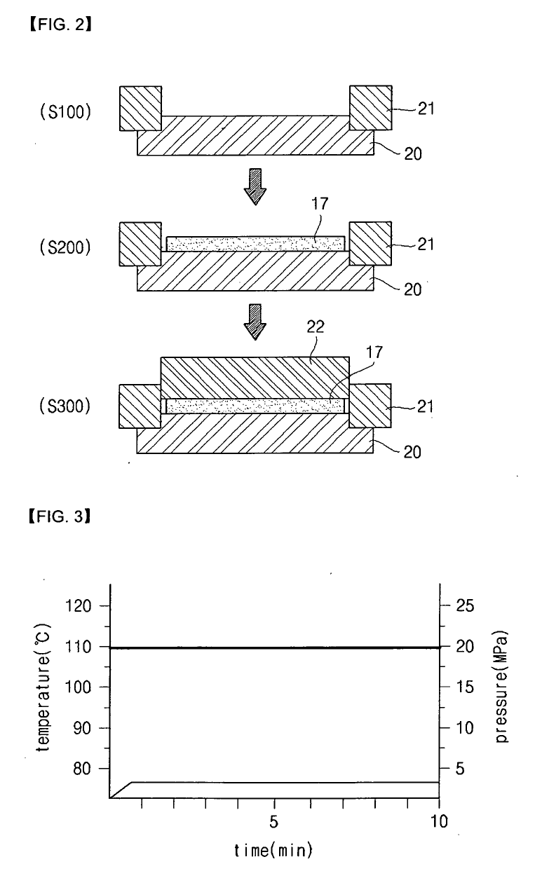

FIG. 1 is a schematic diagram showing a preforming step of a manufacturing method of a separator for a fuel cell according to an exemplary embodiment of the present invention, FIG. 2 is a schematic diagram showing a main forming step of a manufacturing method of a separator for a fuel cell according to an exemplary embodiment of the present invention, FIG. 3 is a graph showing numerical data regarding the preforming step shown in FIG. 1, and FIG. 4 is a graph showing numerical data regarding the main forming step shown in FIG. 2.

The preforming step A for forming the preform 17 with the mixture 13 according to the first and the second embodiments of the present invention includes preparing a first lower mold 10 and a first side mold 12, filling the mixture 13, mounting an additional mold 14, joining a first upper mold 15, pressing and heating.

As shown in FIG. 1, at step S10, the first side molds 12 are respectively coupled to both sides of the first lower mold 10. At step S20, a space surrounded by the first lower mold 10 and the first side mold 12 is filled with the mixture 13.

At step S30, subsequently, a spreader 19 is moved forward and backward so as to uniformly disperse the mixture 13 at a constant height inside the mold.

At step S40, the additional mold 14 is respectively mounted on the first side molds 12. The additional mold 14 is used to ensure a descending passage of the first upper mold 15 and adjusting filling height.

After mounting the additional mold 14, at step S50, the first upper mold 15 is disposed on the mixture 13 and presses the same. At this time, a suspending rod 16 is provided in the middle of the upper mold so as to contact an upper surface of the additional mold 14. A desired thickness of the preform 17 can be obtained by the suspending rod 16.

Thickness of a composite separator is determined according to amount of the filled mixture 13, and the height of the mixture 13 varies according to filling ratio of powder and kind and size of particles. Accordingly, by changing height of the additional mold 14, the filling height can be adjusted and the thickness of the separator can be adjusted.

A preferred polymer is phenolic resin, melting point of which is 90° C. It is generally cured in one minute at 150° C.

This curing time is a time for a state of pure phenolic resin, and in a state in which expanded graphite and flaky graphite, or expanded graphite and carbon fiber are mixed with about 80% by weight, longer time is required for heat transmission. Accordingly, it is preferable that forming temperature of the preform 17 is slightly higher (e.g., 100 to 200° C.) than a melting point of phenolic resin, and it is preferable that it is heated for 5 to 10 minutes so as to prevent excessive curing.

In addition, it is preferable that the thickness of the preform 17 is 5 to 15 mm so as to remove internal gas and make it easier to perform the main forming step B. Since the preform 17 is compressed to extend at the main forming step B, it is preferable four edges of the separator are formed to be less by 0 to 5 mm than desired sizes.

The first side molds 12 are installed to be separable from the first lower mold 10 such that the preform 17 can be easily separated from the mold in horizontal direction after being formed. The preform 17 formed in this way is separated before being completely cured, and is kept in room temperature. Then, the preform 17 is used in the main forming step B.

As shown in FIG. 2, in the main forming process B, second side molds 21 are coupled to both sides of a second lower mold 20 at step S100, and the preform 17 is then inserted into the space formed by the second lower mold 20 and the second side molds 21 at step S200. Then, a second upper mold 22 positioned on the preform 17 and is pressed.

Since the preform 17 is slightly cured at room temperature in the state that the second upper mold 22 is coupled to an upper portion of the preform 17, the preform 17 is preheated for 10 to 60 seconds at temperature of 150 to 180° C. so as to secure secondary flowage of phenolic resin. At this time, preheating pressure is preferably low pressure under 0.5 MPa. After the preheating process, pressure of 1 to 5 MPa is applied and is then cancelled to remove blowholes inside the mixture. And then the separator is formed by forming the preform with pressure of 3 to 15 MPa for 1 to 5 minutes. This process is a fluctuating pressure process.

Blowholes formed within the preform 17 by air existing between powders in the process of compressing and heating of the mixture 13 or vapor formed by evaporation of water contained in phenolic resin are removed in this process. If suitable flowage is obtained, forming is performed with a main forming pressure.

It is preferable that the main forming pressure is 3 to 15 Mpa. If the main forming pressure is less than 3 MPa, complete forming cannot be performed so that electrical conductivity and bending strength are deteriorated. On the other hand, if the main forming pressure is greater than 15 MPa, physical properties are not improved any more.

In the main forming step B, press temperature should be maintained constant from the preheating to the separation from the mold. It is preferable that the forming temperature is maintained between 100 to 200° C. If forming temperature is lower than 100° C., forming time becomes too long. In contrast, if the forming temperature is higher than 200° C., phenolic resin may be destroyed. In addition, it is preferable that the forming is maintained for 1 to 5 minutes. If the forming time is shorter than one minute, electrical and mechanical properties are deteriorated. By contrast, if it is longer than 3 minutes, physical properties are not improved any more.

In order to form the composite separator reinforced by flaky graphite according to the first embodiment of the present invention, mixture was formed with composition ratio of 7% of expanded graphite by weight, 64% of flaky graphite by weight, and 29% of phenolic resin by weight, and a preform with a thickness of 10 mm was formed by forming the mixture for 7 minutes at temperature of 110° C. Then, the preform was preheated for 20 seconds in a high temperature press heated at 150° C. so as to obtain the secondary flowage of the preform, and the pressure was increased to 3.5 MPa and the application of the pressure was then stopped so as to remove blowholes. Then, the pressure was immediately increased to 7 MPa, and the forming was performed for 3 minutes, thereby forming the composite separator reinforced by the flaky graphite.

In addition, in order to form the composite separator reinforced by carbon fiber according to the second embodiment of the present invention, mixture was formed with composition ratio of 6 to 32% of expanded graphite by weight, 30 to 60% of carbon fiber by weight, and 35 to 40% of phenolic resin by weight, and the mixture is formed for 7 minutes at temperature of 110° C. to the thickness of 10 mm. Then, the same main forming process was performed to form the separator reinforced by carbon fiber.

Performance of the composite separators according to the first and the second embodiments of the present invention is described below.

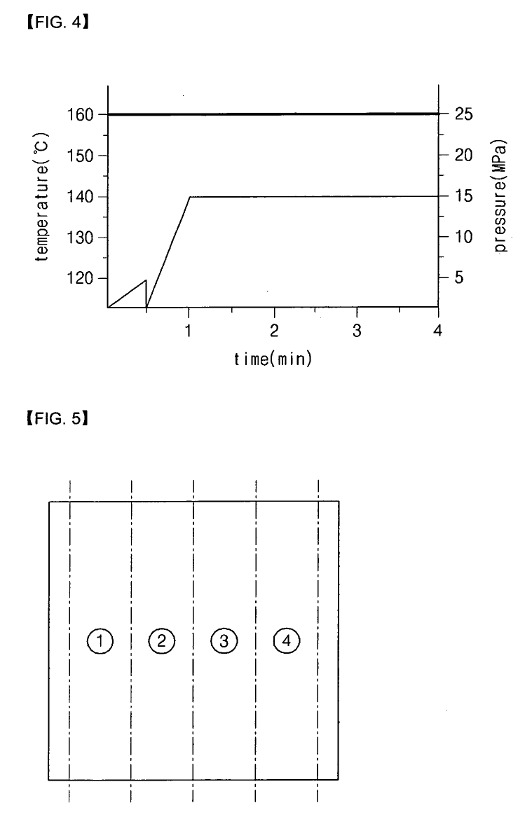

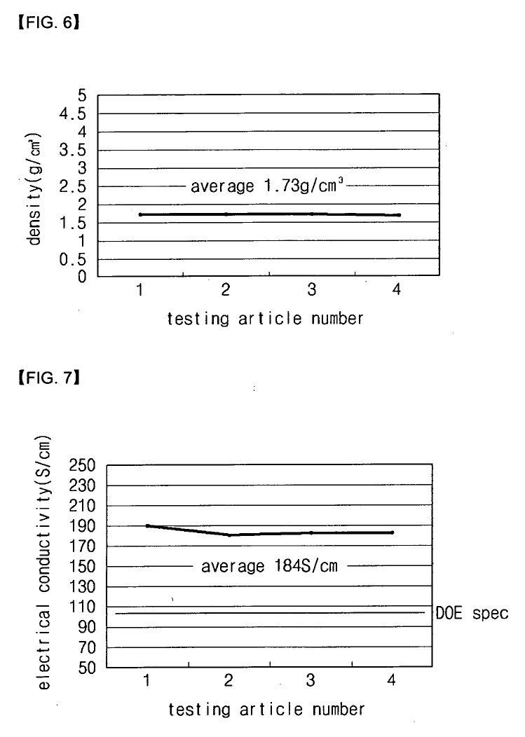

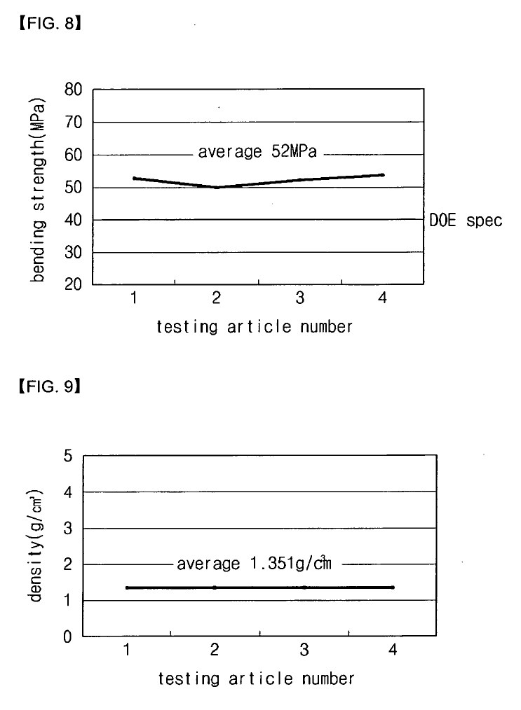

FIG. 5 is a top plan view showing positions of test articles for measuring density, electrical conductivity, and bending strength of a separator for a fuel cell according to an exemplary embodiment of the present invention. FIG. 6 is a graph showing density distribution of a first embodiment of the present invention, FIG. 7 is a graph showing electrical conductivity distribution of a first embodiment of the present invention, and FIG. 8 is a graph showing bending strength distribution of a first embodiment of the present invention.

As shown in FIG. 5, density, electrical conductivity, and bending strength are measured using test articles prepared at four positions of the separator.

The density distributions of the separator reinforced by flaky graphite are in the range of 1.71 to 1.75 g/cm³, average density is 1.73 g/cm³, and standard deviation thereof is 0.013 g/cm³. Similarly, the electrical conductivities are in the range of 180 to 190 S/cm, average electrical conductivity is 184 S/cm, and standard deviation is 3.887 S/cm. The bending strengths are in the range of 49 to 53 MPa, average bending strength is 52 MPa, and standard deviation thereof is 1.683 MPa. All of these distributions depending on the positions are within a range suitable for a PEMFC separator.

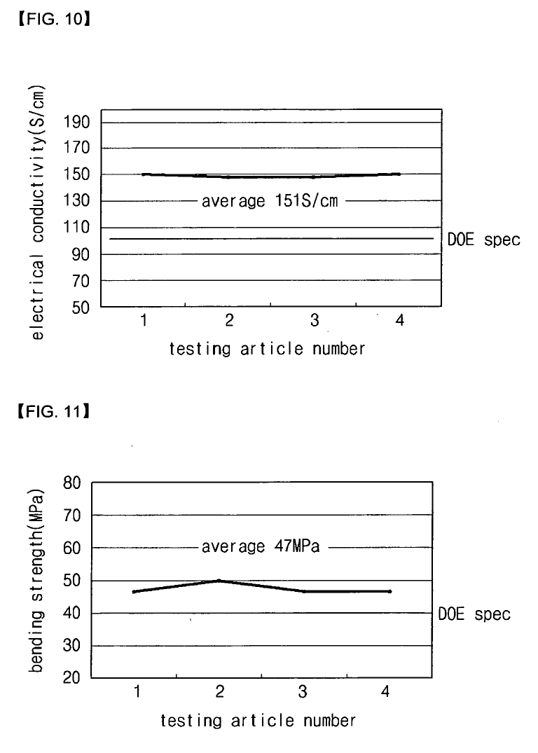

FIG. 9 is a graph showing density distribution of a second embodiment of the present invention, FIG. 10 is a graph showing electrical conductivity distribution of a second embodiment of the present invention, and FIG. 11 is a graph showing bending strength distribution of a second embodiment of the present invention.

Similarly, density, electrical conductivity, and bending strength are measured using test articles prepared at four positions, as shown in FIG. 5, of the separator reinforced by carbon fiber according to the second embodiment of the present invention.

Density distributions of the separator reinforce by carbon fiber are in the range of 1.33 to 1.37 g/cm³, average density is 1.351 g/cm³, and standard deviation thereof is 0.013 g/cm³. Similarly, the electrical conductivities are in the range of 148 to 151 S/cm, average electrical conductivity is 151 S/cm, and standard deviation is 1.136 S/cm. The bending strengths are in the range of 45 to 50 MPa, average bending strength is 47 MPa, and standard deviation thereof is 2.09 MPa. All of these distributions depending on the positions are also within a range suitable for a PEMFC separator.

According to the embodiments of the present invention, since the composite separator is formed through two steps using the mixture of expanded graphite, flaky graphite, and phenolic resin or the mixture of expanded graphite, carbon fiber, and phenolic resin, the drawbacks of the conventional methods can be overcome, and lightweight of the separator can be realized. In addition, time for main forming can be reduced due to the preforming process, so that the separator for a fuel cell can be manufactured more efficiently.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A manufacturing method of a separator for a fuel cell, comprising:
a preforming step for forming a preform of the separator; and
a main forming step for form the separator with the preform.

2. The manufacturing method of claim 1, wherein the preforming step comprises:
mounting first side molds to both sides of a first lower mold;
filling an inner space formed by the first lower mold and the first side molds with a material mixture;
moving a spreader forward and backward so as to uniformly disperse the mixture corresponding to height of the first side molds;
mounting an additional mold on the first side molds so as to adjust a filling height of the mixture; and
mounting a first upper mold on the mixture.

3. The manufacturing method of claim 2, wherein the mixture comprises expanded graphite, a reinforcing material, and a polymer.

4. The manufacturing method of claim 2, wherein the mixture comprises expanded graphite, flaky graphite, and phenolic resin.

5. The manufacturing method of claim 4, wherein the mixture comprises 2 to 20% of expanded graphite by weight, 40 to 70% of flaky graphite by weight, and 20 to 40% of phenolic resin by weight.

6. The manufacturing method of claim 2, wherein the mixture comprises expanded graphite, carbon fiber, and phenolic resin.

7. The manufacturing method of claim 6, wherein the mixture comprises 6 to 32% of expanded graphite by weight, 30 to 60% of carbon fiber by weight, and 20 to 40% of phenolic resin by weight.

8. The manufacturing method of claim 7, wherein the mixture comprises 35 to 40% of phenolic resin by weight.

9. The manufacturing method of claim 2, wherein the preform is formed by forming the mixture at a thickness of 5 to 15 mm for 5 to 10 minutes at temperature of 100 to 120° C. in a state in which the first upper mold is mounted.

10. The manufacturing method of claim 9, wherein four edges of the preform are formed to be less by 0 to 5 mm than a size of the separator, and a thickness of the preform is formed to be greater than that of the separator.

11. The manufacturing method of claim 1, wherein the main forming step comprises:
mounting second side molds to both sides of a second lower mold;
inserting the preform into a space formed by the second lower mold and the second side molds; and
mounting a second upper mold on the preform.

12. The manufacturing method of claim 11, wherein the preform is preheated for 10 to 60 seconds at temperature of 150 to 180° C. at low pressure under 0.5 MPa, and then pressure of 1 to 5 MPa is applied and the application of the pressure is then stopped so as to remove blowholes inside the mixture, in a state in which the second upper mold is mounted, and the separator is formed by performing a fluctuating pressure process of forming the preform with pressure of 3 to 15 MPa for 1 to 5 minutes.

13. A separator manufactured by the method of claim 1.

14. A motor vehicle comprising the separator of claim 13.
